(19) United States
(12) Patent Application Publication
(10) Pub. No.: US 2002/0111288 A1
(43) Pub. Date: Aug. 15, 2002

(54) Branched alkoxide reaction products, and uses thereof

(76) Inventors: Stephen F. Gross, Souderton, PA (US); Wei Li, Mason, OH (US); Norman Tuller, Simpsonville, SC (US); Michael S. Wiggins, Lansdale, PA (US); Norman Milstein, Cincinnati, OH (US)

Correspondence Address: COGNIS CORPORATION, 2500 RENAISSANCE BLVD., SUITE 200, GULPH MILLS, PA, 19406

(21) Appl. No.: 09/969,281

(22) Filed: Oct. 2, 2001

Related U.S. Application Data
(60) Provisional application No. 60/256,375, filed on Dec. 18, 2000.
(60) Provisional application No. 60/267,828, filed on Feb. 9, 2001.

(51) Int. Cl. C11D 1/00

(52) U.S. Cl. 510/479; 510/470

(57) ABSTRACT

The reaction product of (a) a polyol having from 2 to 30 carbon atoms and from 2 to 12 hydroxyl groups, or an alkyl polyglycoside, with (b) an alkoxide of the formula

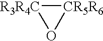

where R₃, R₄, R₅ and R₆ are each independently hydrogen or a C₁-C₄ alkyl group.

The above reaction products can then optionally be capped with one or more hydrophobic groups of the formula R₇X.

The invention also relates to uses therefor as surfactants and defoaming agents in aqueous and nonaqueous liquid compositions.

### CROSS REFERENCE TO RELATED APPLICATION

This application claims the benefit of copending provisional application serial No. 60/256,375, filed on Dec. 18, 2000, and provisional application serial No. 60/267,828 filed on Feb. 9, 2001; the entire contents of each of which are incorporated herein by reference.

### FIELD OF THE INVENTION

This invention relates to compounds useful as low foaming surfactants and defoaming agents in both aqueous and nonaqueous liquid compositions.

### BACKGROUND OF THE INVENTION

Aqueous cleaning compositions exhibit a tendency toward foaming since they contain surface active agents such as soaps, and synthetic detergents. In many instances, such cleaning compositions produce excessive foam and the user must add substances known as anti-foaming agents or defoamers. Some defoamers such as silicones tend to interfere with the function of the cleaning compositions in that unwanted residues are left after the cleaners are wiped off, while others are environmentally unacceptable because they are not biodegradable.

Alkyl polyglycosides are a class of nonionic surfactants that exhibit significantly higher foaming profiles than other nonionic surfactants, such as alcohol ethoxylates. In fact, it can be said that the foaming tendencies of alkyl polyglycosides more closely resemble those of anionic surfactants, such as alcohol sulfates, than the foaming tendencies of other nonionic surfactants. This higher foaming tendency makes the use of alkyl polyglycosides alone undesirable for many applications, e.g. cleaning-in-place for food processing plants, high pressure spray cleaning, bottle washing, floor cleaners and automatic dishwashing, wherein high levels of foam interfere with the cleaning and rinsing operation and reduce the efficiency of the operation.

Low foam nonionics, such as EO/PO block copolymers, can be used to reduce the foaming properties of alkyl polyglycoside surfactants, but these materials have undesirable properties, e.g. low biodegradability, relatively high aquatic toxicity and poor caustic compatibility.

Accordingly, there is a need for the development of defoamers that do not interfere with the cleaning ability of aqueous cleaning compositions and that are biodegradable, exhibit low aquatic toxicity, and good caustic compatibility.

There is also a need for defoamers for nonaqueous compositions.

In addition, there is a continuing need for low foaming surfactants for use in both aqueous and nonaqueous compositions.

### SUMMARY OF THE INVENTION

In a first embodiment, the invention relates to the reaction product of a) (i) a polyol of formula I

R(OH)ₘ (I)

where R is a C₂-C₃₀, preferably a C₂-C₁₂, straight or branched chain substituted or unsubstituted alkyl or alkenyl group, and m is a number of from 2 to 12, or an alkyl polyglycoside of formula II

R₁O(R₂O)_{b}(Z)ₐ (II)

wherein R₁ is a monovalent organic radical, preferably an alkyl or alkenyl group, having from 6 to 30 carbon atoms, preferably from 6 to 20 carbon atoms; R₂ is a divalent alkylene radical having from 2 to 4 carbon atoms; Z is a saccharide residue having 5 or 6 carbon atoms; b is a number having a value from 0 to about 12; a is a number having a value from 1 to 6, with b) an alkoxide of formula III

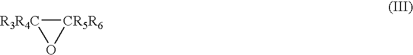

where R₃, R₄, R₅ and R₆ are each independently hydrogen or a C₁-C₄ alkyl group, preferably where R₃, R₅ and R₆ are hydrogen, and R₄ is hydrogen, methyl, or ethyl.

When reactant a) is a polyol of formula I, the reaction product is an alkoxylated polyol of the formula IV

R—(O—(R₃R₄C—C R₅R₆O)ₙH)_{m′} (IV)

wherein R, R₃, R₄, R₅, R₆ and m have the meanings given above, and n=2 to 100, and wherein each group can have the same or a different value for n.

When reactant a) is an alkyl polyglycoside of formula II, the reaction product is an alkoxylated alkyl polyglycoside of formula V

R₁O(R₂O)_{b}Zₐ(O(R₃R₄C—C R₅R₆O)ₙ)ₘ (V)

where R₁, R₂, R₃, R₄, R₅, R₆, Z, a, b and n have the meanings given above, and m is a number ranging from 1 up to the number of free hydroxyl groups present in the polyglycoside, depending on the molar ratios of the reactants.

The above reaction products of formula IV and V can then optionally be capped by reaction with one or more hydrophobic groups of the formula R₇X, where R₇ is a hydrophobic group such as a substituted or unsubstituted aromatic group, or a substituted or unsubstituted alkyl or alkenyl group having from 4 to 30 carbon atoms, and x is halogen, e.g. chlorine, bromine, or iodine, carboxyl, or an epoxy group.

The present invention also relates to uses for the reaction products as low foaming surfactants and as defoaming agents in both aqueous-and nonaqueous-based liquid compositions, such as latex paints, inks, adhesives, metal working compositions, and the like.

### DETAILED DESCRIPTION OF THE INVENTION

Other than in the operating examples, or where otherwise indicated, all 2 o numbers expressing quantities of ingredients or reaction conditions used herein are to be understood as modified in all instances by the term “about”.

In the above reaction products of formula IV the polyol reactant of formula I can have one or more double bonds, and can be substituted, e.g. containing groups such as one or more halogens, e.g. F, Cl, Br, or I, C₁-C₄ alkoxy, acetoxy, cyano, nitro, and the like.

In the above reaction products of formula V the alkyl polyglycoside reactants of formula II preferably have the formula II wherein Z is a glucose residue and b is zero. Such alkyl polyglycosides are commercially available, for example, as APG®, GLUCOPON®, or PLANTAREN® surfactants from Cognis Corporation, Ambler, Pa. 19002. Examples of such surfactants include but are not limited to:

1. APG® 225 Surfactant-an alkyl polyglycoside in which the alkyl group contains 8 to 10 carbon atoms and has an average degree of polymerization of 1.7.

2. APG® 425 Surfactant-an alkyl polyglycoside in which the alkyl group contains 8 to 16 carbon atoms and has an average degree of polymerization of 1.5.

3. APG® 625 Surfactant-an alkyl polyglycoside in which the alkyl group contains 12 to 16 carbon atoms and has an average degree of polymerization of 1.6.

4. APG® 325 Surfactant-an alkyl polyglycoside in which the alkyl group contains 9 to 11 carbon atoms and has an average degree of polymerization of 1.5.

5. GLUCOPON® 600 Surfactant-an alkyl polyglycoside in which the alkyl group contains 12 to 16 carbon atoms and has an average degree of polymerization of 1.4.

6. PLANTAREN® 2000 Surfactant-a C8-16 alkyl polyglycoside in which the alkyl group contains 8 to 16 carbon atoms and has an average degree of polymerization of 1.5.

7. PLANTAREN® 1300 Surfactant-a C12-16 alkyl polyglycoside in which the alkyl group contains 12 to 16 carbon atoms and has an average degree of polymerization of 1.6.

8. GLUCOPON® 220 Surfactant-an alkyl polyglycoside in which the alkyl group contains 8 to 10 carbon atoms and has an average degree of polymerization of 1.5.

Other examples include alkyl polyglycoside compositions which are comprised of mixtures of compounds of formula II wherein Z represents a moiety derived from a reducing saccharide containing 5 or 6 carbon atoms; a is a number having a value from 1 to about 6; b is zero; and R₁ is an alkyl radical having from 8 to 20 carbon atoms.

In the capping group of the formula R₇X, the R₇ group can be substituted with one or more of the substituents given above for the polyols of formula I. When R₇ is an aromatic group, the group is preferably phenyl or substituted phenyl, including alkyl substituted phenyl, although other aromatic groups including polycyclic aromatic groups such as naphthyl can also be used.

The reaction between the polyol of formula I or the alkyl polyglycoside of formula II with the alkoxide of formula III can be carried out by reacting the above reactants at a temperature in the range of from 125° C. to 230° C. in the presence of a basic catalyst (e.g. 0.1 to 3% by weight, based on reactants), such as an alkali metal hydroxide, e.g. sodium or potassium hydroxide, or an alkali metal alkoxylate, e.g. sodium methylate or ethylate and the like. The above reaction is preferably carried out under an inert atmosphere, such as a nitrogen atmosphere. It is also preferred to add the alkoxide to the hot formula I or II reactant containing the basic catalyst by slow addition.

The optional reaction between the capping agent R₇X and the reaction product obtained above can be carried out by slow addition of the capping agent to the reaction product at a temperature in the above range.

In a second embodiment of the invention, the reaction products of the invention, including those that are further reacted with the capping agent, can be used as low foaming surfactants in both aqueous and nonaqueous compositions in surfactant-effective amounts, usually from 0.1 to 10% by weight, preferably from 1 to 5% by weight, based on the weight of the composition.

These reaction products can also be used in the above quantities as defoaming agents for aqueous and nonaqueous compositions, and are particularly useful in minimizing or eliminating foaming in aqueous compositions containing high foaming surfactants, such as alkyl polyglycosides and anionic surfactants such as alcohol sulfates.

These reaction products can be used in aqueous cleaning compositions, in emulsion polymer latex compositions such as latex paints, in inks, in adhesives, in metal working compositions, and in other aqueous and nonaqueous compositions in which surfactants and/or defoaming agents are advantageously present.

The reaction products of the invention are biodegradable, contain no organic solvents, and do not adversely affect the detergency of other surfactants that may be present in compositions in which they are used since they are themselves surfactants.

The invention will be illustrated but not limited by the following examples.

### EXAMPLES

### Example 1

Synthesis of POE (15) Glycerol Epoxyoctane Adduct.

78.25 of g of POE (15) glycerol and 0.505 g KOH were placed in a 250 ml three neck flask, which was equipped with an addition funnel, a mechanical stirrer and a thermometer. The mixture was purged with nitrogen for 15 minutes, and heated to 140-145° C. 40.13 g of epoxyoctane was added over 30 minutes at the temperature. After the addition, the reaction was held at 145° C. for one hour. The reaction mixture was cooled to 35° C. and neutralized with 0.54 g acetic acid. GC analysis showed no residual epoxyoctane. 112 g product was obtained (yield 96.2%). The final product had a hydroxyl value of 157.7 (theoretical 150.9).

### Example 2

Synthesis of POE (15) Glycerol Epoxydecane Adduct.

78.28 g of POE (15) glycerol and 0.505 g KOH were placed in a 250 ml three neck flask, which was equipped with an addition funnel, a mechanical stirrer and a thermometer. The mixture was purged with nitrogen for 15 minutes, and heated to 140-145° C. 50.88 g of epoxydecane was added over 30 minutes at the above temperature. After the addition, the reaction was held at 145° C. for one hour. The reaction mixture was cooled to 45° C. and neutralized with 0.540 g acetic acid. GC analysis showed no residual epoxyoctane. 121 g product was obtained (yield 95.1%). The final product has a hydroxyl value of 145.2 (theoretical 140.3).

### Example 3

Synthesis of POE (15) Glycerol Epoxyoctane Adduct Capped with Decyl Chloride

The reaction product obtained in Example 1 is reacted with two moles of decyl chloride per mole of reaction product, at a temperature of 120° C. in the presence of 0.5 g of NaOH for a period of one hour.

The resulting reaction mixture is cooled to 35° C. and neutralized with 0.6g acetic acid.

### Example 4

Synthesis of POE (15) Glycerine Tris-(2-Hydroxydecyl)-Ether

135 g of POE (15) glycerine, containing NaOH catalyst from its preparation, was heated to 150° C. in a reaction flask. 100 g of 1,2-epoxydecane was weighed into an equalizing addition funnel. The 1,2-epoxydecane was then added to the flask dropwise over the period of one hour. No exothermic reaction was noted. Heating was continued at 150° C. for three hours. The NaOH in the reaction mixture was neutralized with 0.06 g of acetic acid. A full oil pump vacuum was applied at 150° C. to distill off any residual 1,2-epoxydecane.

The resulting reaction mixture weighed 222 g and had a color of 3+ on the Gardner scale. The reaction mixture was slowly filtered at room temperature through Celite. The filtrate was sparkling clear.

Gas chromatographic analysis of the filtrate product did not detect any unreacted 1,2-epoxydecane.

What is claimed is:

1. The reaction product of a) at least one polyol having from 2 to 30 carbon atoms and from 2 to 12 hydroxyl groups or at least one alkyl polyglycoside, and b) an alkoxide of the formula III 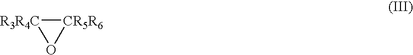
where R₃, R_{4,} R₅ and R₆ are each independently hydrogen or a C₁-C₄ alkyl group, and wherein said reaction product is optionally capped with a compound of the formula R₇X where R₇ is a hydrophobic group and X is halogen, carboxyl, or epoxy.

2. The reaction product of claim 1 wherein reactant a) is at least one polyol having the formula I
R(OH)ₘ (I)
where R is a C₂-C₃₀ straight or branched chain substituted or unsubstituted alkyl or alkenyl group, and m is a number of from 2 to 12.

3. The reaction product of claim 1 wherein reactant a) is at least one alkyl polyglycoside of formula II
R₁O(R₂O)_{b}(Z)ₐ (II)
wherein R₁ is a monovalent organic radical having from about 6 to about 30 carbon atoms; R₂ is a divalent alkylene radical having from 2 to 4 carbon atoms; Z is a saccharide residue having 5 or 6 carbon atoms; b is a number having a value from 0 to about 12; a is a number having a value from 1 to about 6.

4. The reaction product of claim 1 wherein in the reactant b) alkoxide, R₃, R₅ and R₆ are hydrogen and R₄ is hydrogen, methyl, or ethyl.

5. The reaction product of a) at least one polyol of the formula I
R(OH)ₘ (I)
where R is a C₂-C₁₂ straight or branched chain substituted or unsubstituted alkyl or alkenyl group, and m is a number of from 2 to 12, and b) an alkoxide of the formula 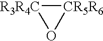
where R₃, R_{4,} R₅ and R₆ are each independently hydrogen or a C₁-C₄ alkyl group.

6. The reaction product of claim 5 wherein R is a substituted group in which one or more halogens, acetoxy groups, cyano groups, and/or nitro groups are present thereon.

7. The reaction product of claim 5 wherein in the reactant b) alkoxide, R₃, R₅ and R₆ are hydrogen and R₄ is hydrogen, methyl or ethyl.

8. The reaction product of claim 5 where the reaction product is capped with a compound of the formula R₇X where R₇ is a hydrophobic group and X is halogen, carboxyl, or epoxy.

9. The reaction product of a) an alkyl polyglycoside of the formula II
R₁O(R₂O)_{b}(Z)ₐ (II)
wherein R₁ is an alkyl group having from 6 to 20 carbon atoms, a is a number having a value of from 1 to about 6, b=zero, and Z is a glucose residue, and b) an alkoxide of formula III 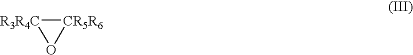
where R₃, R₄, R₅ and R₆ are each independently hydrogen or a C₁-C₄ alkyl group.

10. The reaction product of claim 9 wherein in the reactant b) alkoxide, R₃, R₅ and R₆ are hydrogen and R₄ is hydrogen, methyl or ethyl.

11. The reaction product of claim 9 where the reaction product is capped with a compound of the formula R₇X where R₇ is a hydrophobic group and X is halogen, carboxyl, or epoxy.

12. In an aqueous composition, the improvement wherein a surfactant- or defoaming-effective quantity of the reaction product of claim 1 is present therein.

13. The composition of claim 12 wherein the surfactant- or defoaming-effective quantity is from about 0.1 to about 10% by weight.

14. The composition of claim 13 wherein the composition is a latex paint composition.

15. In an aqueous composition containing an alkyl polyglycoside and/or an alcohol sulfate, the improvement wherein a defoaming-effective quantity of the reaction product of claim 1 is present therein.

16. In a nonaqueous liquid composition, the improvement wherein a surfactant- or defoaming-effective quantity of the reaction product of claim 1 is present therein.

17. The nonaqueous liquid composition of claim 16 wherein the composition is an ink, an adhesive, or a metal working composition.

18. The nonaqueous liquid composition of claim 16 wherein the surfactant-effective quantity is from about 0.1 to about 10% by weight.

19. In an aqueous composition, the improvement wherein a surfactant- or defoaming-effective quantity of the reaction product of claim 5 is present therein.

20. The composition of claim 19 wherein the surfactant- or defoaming-effective quantity is from about 0.1 to about 10% by weight.

21. The composition of claim 20 wherein the composition is a latex paint composition.

22. In an aqueous composition containing an alkyl polyglycoside and/or an alcohol sulfate, the improvement wherein a defoaming-effective quantity of the reaction product of claim 5 is present therein.

23. In a nonaqueous liquid composition, the improvement wherein a surfactant- or defoaming-effective quantity of the reaction product of claim 5 is present therein.

24. The nonaqueous liquid composition of claim 23 wherein the composition is an ink, an adhesive, or a metal working composition.

25. The nonaqueous liquid composition of claim 23 wherein the surfactant- or defoaming-effective quantity is from about 0.1 to about 10% by weight.
